(19) United States
(12) Patent Application Publication
(10) Pub. No.: US 2020/0392963 A1
(43) Pub. Date: Dec. 17, 2020

(54) FAN MOTOR, FAN MOTOR DRIVE DEVICE, AND COOLING DEVICE

(71) Applicant: FANUC CORPORATION, Yamanashi (JP)

(72) Inventors: Masaya TATEDA, Yamanashi (JP); Kenichi OKUAKI, Yamanashi (JP)

(73) Assignee: FANUC CORPORATION, Yamanashi (JP)

(21) Appl. No.: 16/893,251

(22) Filed: Jun. 4, 2020

(30) Foreign Application Priority Data
Jun. 12, 2019 (JP) 2019-109571

(51) Int. Cl. F04D 27/00; F04D 19/00; F04D 25/08

(52) U.S. Cl. CPC F04D 27/001; F05B 2270/80; F04D 25/08; F04D 19/002

(57) ABSTRACT

A fan motor drive device is connected to a fan motor so as to drive the fan motor. The fan motor drive device includes an operation control part configured to control operation of the fan motor and a determination part configured to determine the quality of the fan motor on the basis of an identification signal, which indicates an operation state of the fan motor and is output on the basis of a predetermined operation controlled by the operation control part.

This application is based on and claims the benefit of priority from Japanese Patent Application No. 2019-109571, filed on 12 Jun. 2019, the content of which is incorporated herein by reference.

### BACKGROUND OF THE INVENTION

### Field of the Invention

The present invention relates to a fan motor, a fan motor drive device, and a cooling device.

### Related Art

Industrial machinery including an industrial robot and/or a machine tool equipped with a computerized numerical controller (CNC) configured to execute machining is known conventionally. The operation of such industrial machinery is controlled by use of the computerized numerical controller. The industrial machinery and the computerized numerical controller respectively include a cooling device configured to suppress internal temperature rise.

The cooling device includes, for example, a fan motor and a fan motor drive device configured to drive the fan motor. In the cooling device, the fan motor drive device supplies power to the fan motor to make the fan motor operate. The cooling device is capable of cooling predetermined equipment by generating cooling air by the operation of the fan motor.

The cooling device is capable of detecting an abnormality in the fan motor by monitoring the operation of the fan motor. A machine tool has been proposed, in which, for example, the rotation number of the fan motor is monitored, thereby detecting lowering of the rotation of the fan motor (refer to, for example, Patent Document 1).

Patent Document 1: Japanese Unexamined Patent Application, Publication No. 2016-140946

### SUMMARY OF THE INVENTION

In a general cooling device, the fan motor thereof is interchangeable with another fan motor. In a general cooling device, the fan motor thereof is controlled in terms of the voltage value of the driving power to be supplied or a rotation number (rotations per minute, rotations per second). Therefore, in an example, if the fan motor is interchanged with a fan motor generating less cooling air even with the same voltage value or the same rotation number, insufficient cooling can result. Therefore, it is desirable to be able to easily check whether or not a fan motor is suitable.

(1) The present disclosure in one aspect relates to a fan motor drive device connected to a fan motor so as to drive the fan motor. The fan motor drive device includes an operation control part configured to control operation of the fan motor, and a determination part configured to determine the quality of the fan motor on the basis of an identification signal, which indicates an operation state of the fan motor and is output on the basis of a predetermined operation controlled by the operation control part.

(2) The present disclosure in one aspect relates to a fan motor configured to operate by supplied driving power. The fan motor includes a fan motor main body having a plurality of fan blades configured to rotate around an axis, an operation signal output part configured to convert an operation state of the fan motor main body into a signal and output the signal, a detection part configured to detect a specific operation state of the fan motor main body, and an identification signal output part configured to output an identification signal indicating an operation state different from an actual operation state in place of the signal output by the operation signal output part, in response to the detection of the specific operation state.

(3) The present disclosure in one aspect relates to a cooling device including the fan motor drive device described above, and the fan motor described above.

The present disclosure in one aspect is able to provide a fan motor, a fan motor drive device, and a cooling device capable of easily checking whether or not the fan motor is suitable.

### BRIEF DESCRIPTION OF THE DRAWINGS

FIG. 1 is a schematic configuration diagram illustrating a cooling device according to a first embodiment.

FIG. 2 is a block diagram illustrating a fan motor of the first embodiment.

FIG. 3 is a graph indicating the relation between a voltage value applied to the fan motor of the first embodiment and a rotation number.

FIG. 4 is a graph indicating the relation between a voltage value applied to the fan motor of the first embodiment and an output signal.

FIG. 5 is a graph indicating the relation between a predetermined voltage value applied to the fan motor of the first embodiment and an output identification signal.

FIG. 6 is a block diagram illustrating a fan motor drive device of the first embodiment.

FIG. 7 is a graph indicating the relation between a voltage value applied to a fan motor according to a second embodiment and an output signal.

FIG. 8 is a graph indicating the relation between a voltage value applied to the fan motor according to the second embodiment and an output identification signal.

FIG. 9 is a graph indicating the relation between a commanded rotation number input to a fan motor according to a third embodiment and an output signal.

FIG. 10 is a graph indicating the relation between a commanded rotation number input to the fan motor according to the third embodiment and an output identification signal.

FIG. 11 is a graph indicating a modification of the relation between a predetermined voltage value applied to the fan motor of the first embodiment and an output identification signal.

FIG. 12 is a graph indicating a modification of the relation between a voltage value applied to the fan motor according to the second embodiment and an output signal.

FIG. 13 is a graph indicating a modification of the relation between a commanded rotation number input to the fan motor according to the third embodiment and an output signal.

### DETAILED DESCRIPTION OF THE INVENTION

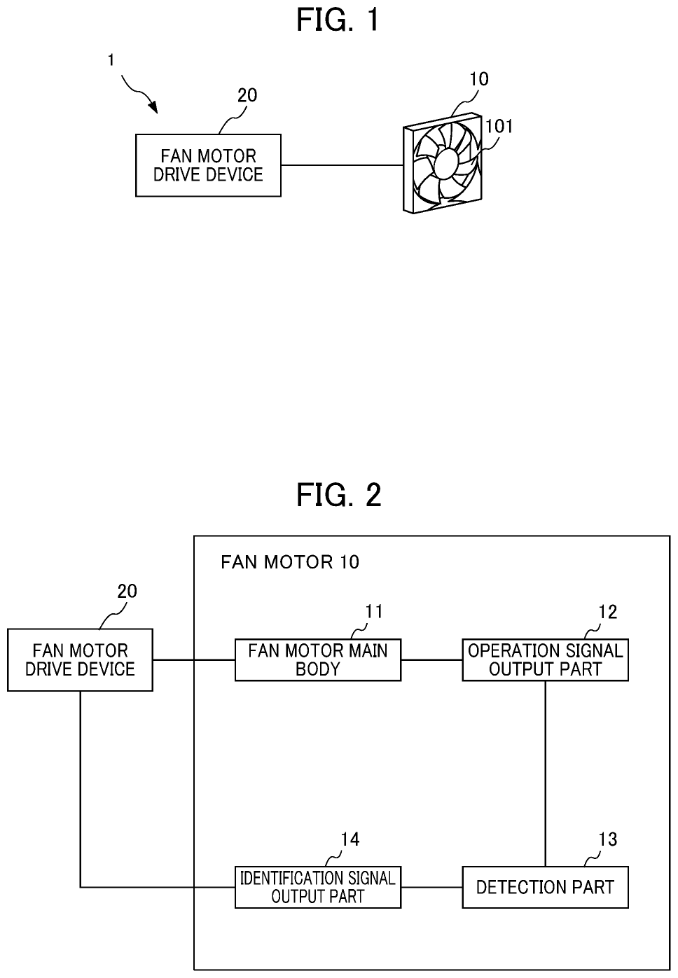

A fan motor 10, a fan motor drive device 20, and a cooling device 1 according to each embodiment of the present disclosure will be described below by referring to FIGS. 1 to 13.

### First Embodiment

The cooling device 1 is incorporated into predetermined equipment, for example, a precision instrument (not shown). The cooling device 1 is configured to generate cooling air to cool the interior of the predetermined equipment. In the present embodiment, the cooling device 1 is incorporated into, for example, industrial machinery or a computerized numerical controller. The cooling device 1 is configured to cool the interior of the industrial machinery, the computerized numerical controller or the like incorporated thereinto. As shown in FIG. 1, the cooling device 1 includes the fan motor 10 and the fan motor drive device 20.

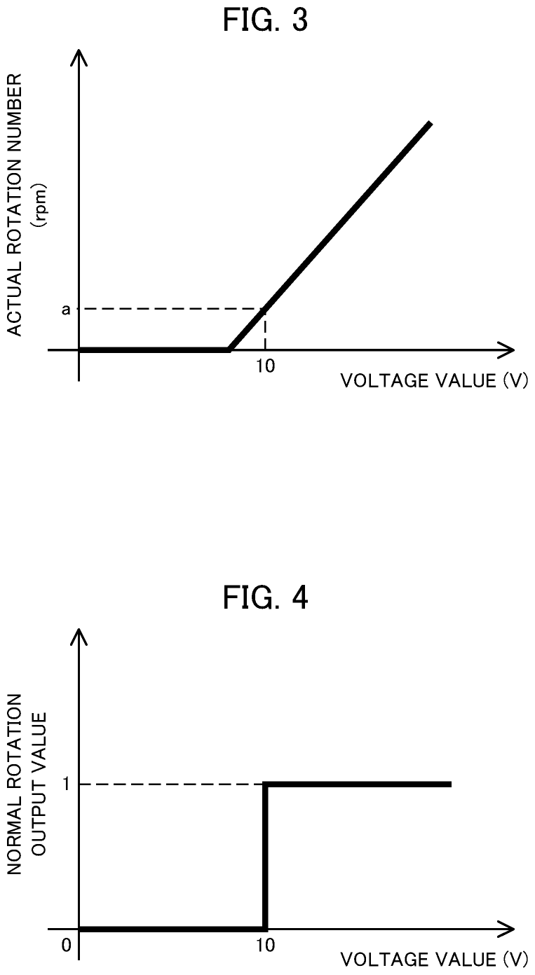

The fan motor 10 is, for example, a blower configured to be driven by a predetermined driving voltage. As shown in FIG. 2, the fan motor 10 includes a fan motor main body 11, an operation signal output part 12, a detection part 13, and an identification signal output part 14. As shown in FIG. 3, the fan motor 10 rotates at a rotation number (for example, rotations per minute or rotations per second) proportional to an input voltage.

The fan motor main body 11 is a blowing fan. The fan motor main body 11 has a plurality of fan blades 101 configured to rotate around an axis. The fan motor main body 11 generates cooling air by rotating the plurality of fan blades 101.

The operation signal output part 12 is, for example, a rotary type encoder. The operation signal output part 12 is configured to output an operation state of the fan motor main body 11 as a signal. In the present embodiment, as shown in FIGS. 3 and 4, the operation signal output part 12 outputs a rotation number (rotations per minute, rotations per second) equal to a predetermined rotation number a or higher of the fan motor main body 11 as a high signal, as an example. On the other hand, the operation signal output part 12 outputs a rotation number lower than the predetermined rotation number a of the fan motor main body 11 as a low signal. As one example, the operation signal output part 12 outputs the rotation number corresponding to the input voltage of 10V or a higher rotation number as a high signal. The operation signal output part 12 outputs the fact that the fan motor main body 11 is rotating at the rotation number a or higher as a signal to the outside.

The detection part 13 is, for example, a signal detection circuit. The detection part 13 detects a specific operation state of the fan motor main body 11. In the present embodiment, the detection part 13 detects a rotation number of the fan motor main body 11 falling within a specific range on the basis of the signal output by the operation signal output part 12.

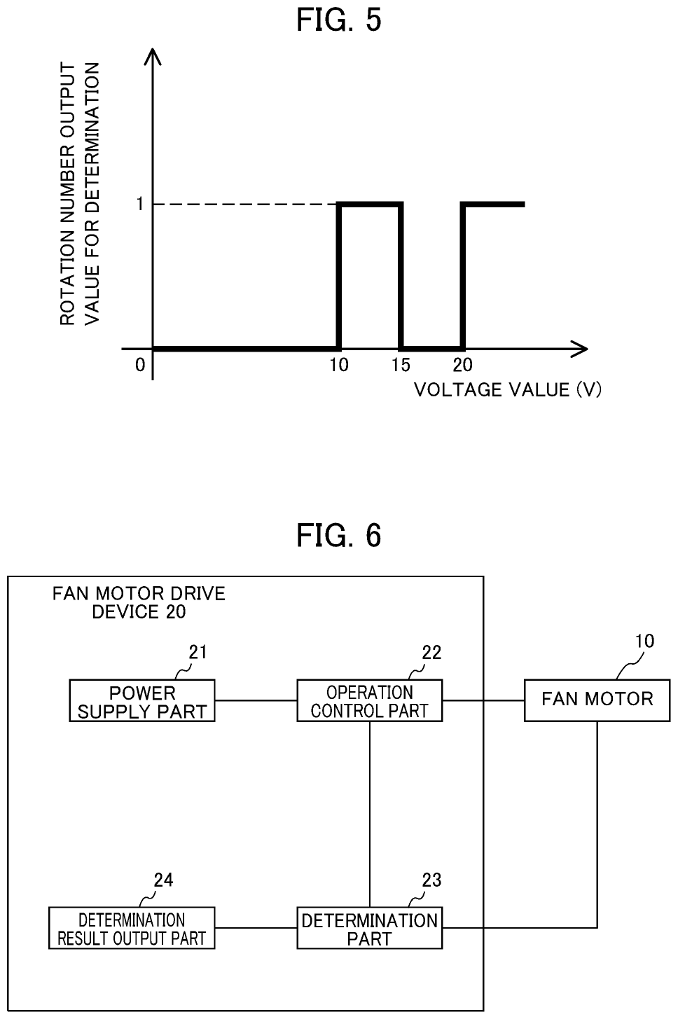

The identification signal output part 14 is a circuit configured to output a predetermined identification signal. The identification signal output part 14 outputs, in response to the detection of the specific operation state, the identification signal indicating an operation state different from the actual operation state in place of the signal output by the operation signal output part 12. In the present embodiment, as shown in FIG. 5, the identification signal output part 14 outputs the low signal in response to the detection by the detection part 13 of a rotation number falling within a specific range. Specifically, the identification signal output part 14 outputs the low signal in place of the high signal output by the operation signal output part 12. In an example, the identification signal output part 14 inverts the high signal output by the operation signal output part 12 to the low signal and outputs the low signal. In the present embodiment, the identification signal output part 14 outputs the low signal in response to an application to the fan motor main body 11 of a voltage value falling within the range from 15V to 20V.

The fan motor drive device 20 is connected to the fan motor 10 so as to drive the fan motor 10. The fan motor drive device 20 is, for example, a fan controller. The fan motor drive device 20 is configured to supply driving power to the fan motor 10 and to determine the quality of the fan motor 10. As shown in FIG. 6, the fan motor drive device 20 includes a power supply part 21, an operation control part 22, a determination part 23, and a determination result output part 24.

The power supply part 21 is a circuit configured to supply power to the fan motor 10. The power supply part 21 drives the fan motor 10 by applying a predetermined operation voltage to the fan motor 10.

The operation control part 22 is configured, for example, when a CPU operates. The operation control part 22 controls the operation of the fan motor 10 by controlling the power to be supplied. In an example, the operation control part 22 changes the voltage value to be applied by the power supply part 21 to the fan motor 10 to control the operation of the fan motor 10. The operation control part 22 changes the voltage value to be applied to the fan motor 10 to a predetermined voltage value different from the normal voltage value for making the fan motor 10 operate.

The determination part 23 is configured, for example, when the CPU operates. The determination part 23 determines the quality of the fan motor 10 on the basis of the identification signal, which indicates an operation state of the fan motor 10 and is output on the basis of a predetermined operation controlled by the operation control part 22. The determination part 23 identifies the identification signal indicating an operation state different from an expected operation state by the application of a predetermined voltage value by the operation control part 22 to the fan motor 10, to determine the quality of the fan motor 10. In the present embodiment, by identifying the low signal as the identification signal, the determination part 23 determines the fan motor 10 as being not defective. On the other hand, in the case of failing to identify the identification signal (in the case where only the high signal is output), the determination part 23 determines the fan motor 10 as being defective. That is, the determination part 23 determines whether or not the fan motor 10 is capable of outputting the identification signal.

The determination result output part 24 is, for example, a display device such as a display or a playback device configured to playback audio. The determination result output part 24 outputs the determination result performed by the determination part 23. In an example, the determination result output part 24 outputs the quality of the fan motor 10 to the outside as the determination result.

The fan motor 10, the fan motor drive device 20, and the cooling device 1 are described in terms of their operation next. First, the operation control part 22 makes the power supply part 21 supply a predetermined voltage value to the fan motor 10 to make the identification signal output part 14 output the identification signal. The fan motor main body 11 starts to rotate by the application of a predetermined voltage value.

Along with the rotation of the fan motor main body 11, the operation signal output part 12 outputs a rotation number of the fan motor main body 11 as a signal. The detection part 13 detects a specific rotation number of the fan motor main body 11 from the signal output by the operation signal output part 12. The identification signal output part 14 outputs, in response to the detection of a specific rotation number by the detection part 13, the identification signal indicating an operation state different from the actual operation state. In the present embodiment, the identification signal output part 14 outputs the low signal as the identification signal.

The determination part 23 determines the fan motor 10 as being not defective by identifying the identification signal. Specifically, the determination part 23 identify the low signal as the identification signal in the signal output by the fan motor 10 to determine the fan motor 10 as being not defective. That is, by identifying the low signal as the identification signal, the determination part 23 determines that the target fan motor 10 is suitable as the fan motor 10 for use by the fan motor drive device 20. On the other hand, in the case of failing to identify the identification signal in the signal output by the fan motor 10, the determination part 23 determines the fan motor 10 as being defective. That is, in the case of failing to identify the identification signal (in the case where only the high signal is output), the determination part 23 determines that the target fan motor 10 is not suitable as the fan motor 10 for use by the fan motor drive device 20. Thereafter, the operation control part 22 applies a voltage value (for example, 20V) allowing to output a normal rotation number to the fan motor 10. The fan motor 10 thereby operates at the rotation number for the normal state. The determination result output part 24 outputs the determination result obtained by the determination part 23 to the outside.

The fan motor 10, the fan motor drive device 20, and the cooling device 1 according to the first embodiment exhibit the following effects.

(1) The fan motor drive device 20 is connected to the fan motor 10 so as to drive the fan motor 10. The fan motor drive device 20 includes the operation control part 22 configured to control operation of the fan motor 10 and the determination part 23 configured to determine the quality of the fan motor 10 on the basis of the identification signal, which indicates an operation state of the fan motor 10 and is output on the basis of a predetermined operation controlled by the operation control part 22. This allows to determine whether or not the fan motor 10 is suitable to perform cooling, by use of the identification signal. Accordingly, it is possible to easily check whether or not sufficient cooling air is generated.

(2) The determination part 23 determines the quality of the fan motor 10 by identifying the identification signal indicating an operation state different from an expected operation state by the application of a predetermined voltage value by the operation control part 22 to the fan motor 10. Since the identification signal is able to be obtained simply by setting the voltage value to be applied to the fan motor 10 to a predetermined value, the quality of the fan motor 10 is able to be checked more easily.

(3) The fan motor 10 is configured to operate by supplied driving power. The fan motor 10 includes the fan motor main body 11 having the plurality of fan blades 101 configured to rotate around an axis, the operation signal output part 12 configured to convert an operation state of the fan motor main body 11 into a signal and output the signal, the detection part 13 configured to detect a specific operation state of the fan motor main body 11, and the identification signal output part 14 configured to output an identification signal indicating an operation state different from an actual operation state in place of the signal output by the operation signal output part 12 in response to the detection of the specific operation state. This allows to provide the fan motor 10 which is easily identified from other fan motors 10.

(4) The cooling device 1 includes the fan motor drive device 20 described above and the fan motor 10 described above. This allows to provide the fan motor drive device 20 and the fan motor 10 in a set.

### Second Embodiment

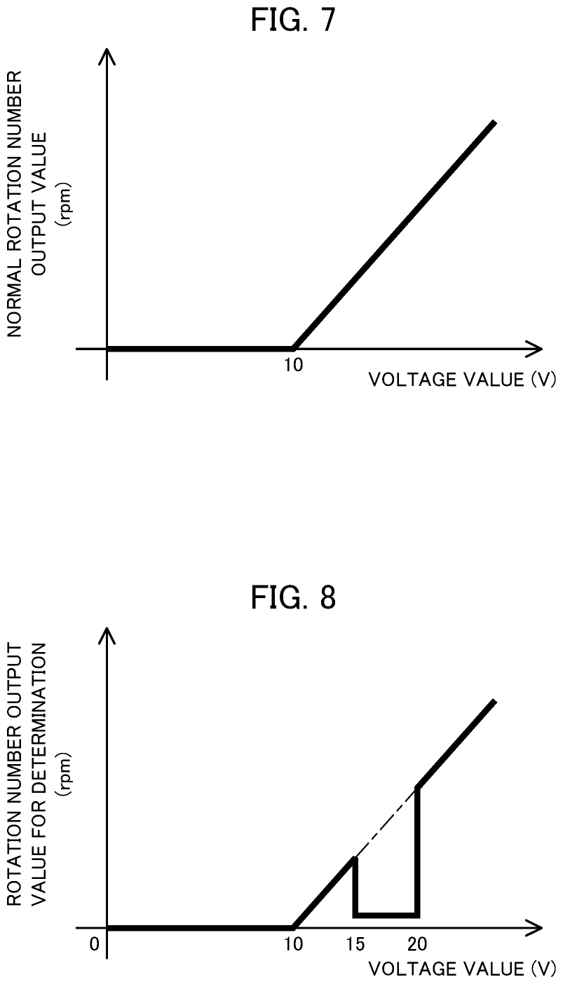

The fan motor 10, the fan motor drive device 20, and the cooling device 1 according to a second embodiment of the present disclosure will be described next by referring to FIGS. 7 and 8. In the description of the second embodiment, the same reference numerals are assigned to the same configurations as those in the above-described embodiment, and the descriptions thereof will be omitted or simplified. The fan motor 10 according to the second embodiment is different from the fan motor 10 according to the first embodiment, in that the operation signal output part 12 outputs the actual rotation number of the fan motor main body 11 as a signal, as shown in FIG. 7. In addition, the fan motor 10 according to the second embodiment is different from the fan motor 10 according to the first embodiment, in that the identification signal output part 14 outputs, as shown in FIG. 8, a rotation number different from the actual rotation number as the identification signal. The fan motor drive device 20 according to the second embodiment is different from the fan motor drive device 20 according to the first embodiment, in that the determination part 23 determines the quality of the fan motor 10 by identifying the identification signal indicating a rotation number different from an expected rotation number by the application of a predetermined voltage value by the operation control part 22 to the fan motor 10. In an example, the determination part 23 identifies the identification signal indicating a predetermined rotation number or lower to determine the quality of the fan motor 10.

Specifically, the determination part 23 identifies the identification signal indicating a rotation number different from an expected rotation number (indicated by a one-dot chain line in FIG. 8) by the application of the predetermined voltage value to the fan motor 10. By identifying the identification signal as described above, the determination part 23 determines that the target fan motor 10 is suitable as the fan motor for use by the fan motor drive device 20. On the other hand, in the case of failing to identify the identification signal (in the case where the output rotation number is the same or substantially the same as an expected rotation number), the determination part 23 determines that the target fan motor 10 is not suitable as the fan motor 10 for use by the fan motor drive device 20.

The fan motor 10, the fan motor drive device 20, and the cooling device 1 according to the second embodiment exhibit the following effects.

(5) The determination part 23 determines the quality of the fan motor 10 by identifying the identification signal indicating a rotation number different from an expected rotation number by the application of the predetermined voltage value by the operation control part 22 to the fan motor 10. This allows to easily check the quality even of a fan motor 10 configured to output the rotation number of the fan motor 10 as is, as a signal.

### Third Embodiment

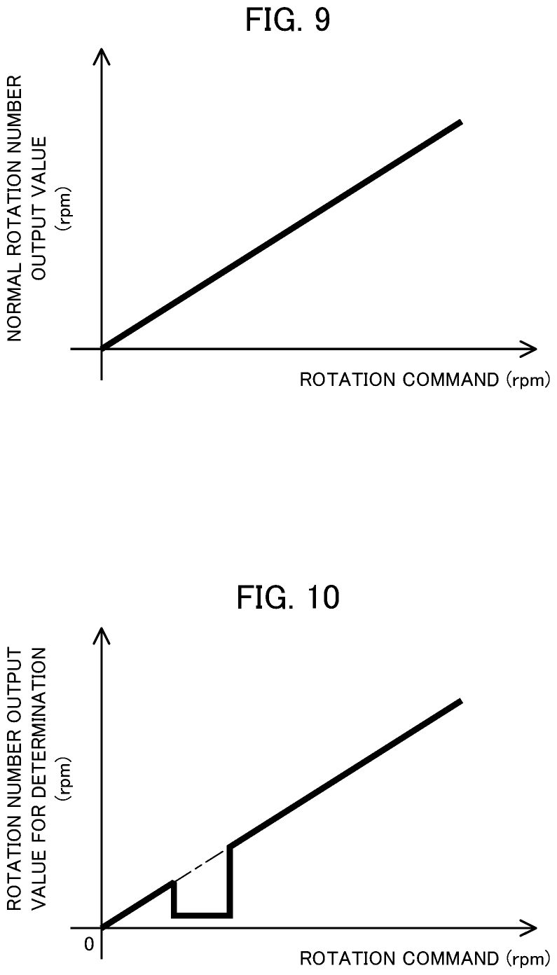

The fan motor 10, the fan motor drive device 20, and the cooling device 1 according to a third embodiment of the present disclosure will be described next by referring to FIGS. 9 and 10. In the description of the third embodiment, the same reference numerals are assigned to the same configurations as those in the above-described embodiments, and the descriptions thereof will be omitted or simplified. The fan motor drive device 20 according to the third embodiment is different from the fan motor drive devices 20 according to the first and second embodiments, in that the operation control part 22 controls the rotation number of the fan motor main body 11, as shown in FIG. 9. The fan motor 10 according to the third embodiment is different from the fan motor 10 according to the first embodiment, in that the operation signal output part 12 outputs the actual rotation number of the fan motor main body 11 as a signal. In addition, the fan motor 10 according to the third embodiment is different from the fan motor 10 according to the first embodiment, in that the identification signal output part 14 outputs a rotation rate different from the actual rotation rate as the identification signal, as shown in FIG. 10. The fan motor drive device 20 according to the third embodiment is different from the fan motor drive device 20 according to the first embodiment, in that the determination part 23 determines the quality of the fan motor 10 by identifying the identification signal indicating an operation state different from an expected operation state of the fan motor 10 by the predetermined rotational control of the fan motor 10 performed by the operation control part 22. In an example, the determination part 23 identifies the identification signal indicating a predetermined rotation number or lower to determine the quality of the fan motor 10.

Specifically, the determination part 23 identifies the identification signal indicating a rotation number different from an expected rotation number (indicated by a one-dot chain line in FIG. 10) by the control to the fan motor 10 with the rotation number specified. That is, the determination part 23 identifies the identification signal indicating the rotation number which is never output with the specified rotation number. By identifying the identification signal, the determination part 23 determines that the target fan motor 10 is suitable as the fan motor 10 for use by the fan motor drive device 20. On the other hand, in the case of failing to identify the identification signal (in the case where the output rotation number is the same or substantially the same as an expected rotation number), the determination part 23 determines that the target fan motor 10 is not suitable as the fan motor 10 for use by the fan motor drive device 20.

The fan motor 10, the fan motor drive device 20, and the cooling device 1 according to the third embodiment exhibit the following effects.

(6) The determination part 23 determines the quality of the fan motor 10 by identifying the identification signal indicating an operation state different from an expected operation state by predetermined rotational control of the fan motor 10 performed by the operation control part 22. This allows to easily check the quality even of a fan motor 10 configured to control a rotation number of the fan motor 10.

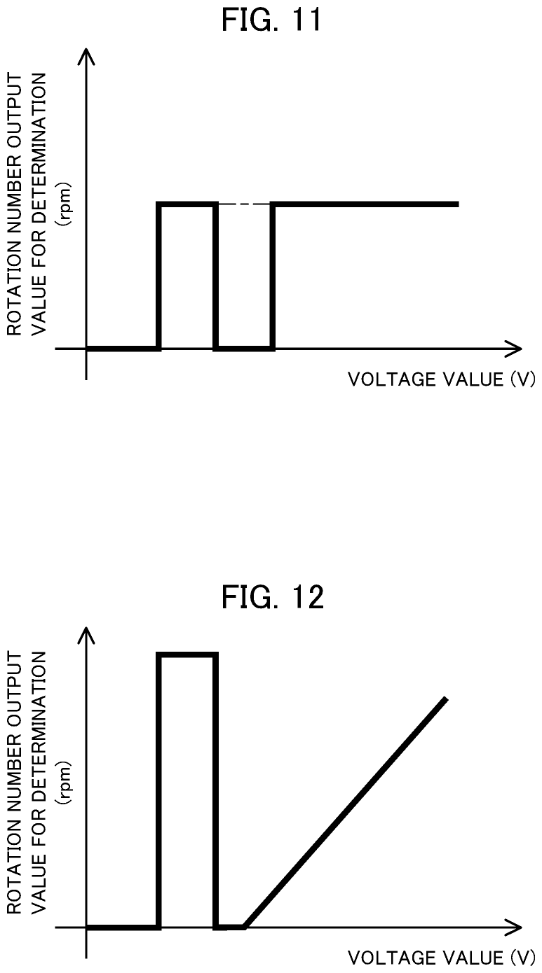

The descriptions above are about respective preferable embodiments of the fan motor, the fan motor drive device, and the cooling device in the disclosure. The present disclosure is not limited to the above-described embodiments. Appropriate changes are available. In an example, in the first embodiment described above, the operation control part 22 may apply, to the fan motor 10, an input voltage (for example, in a range from 3V to 6V) at which the fan motor main body 11 does not rotate as a predetermined voltage value. The identification signal output part 14 may output, as shown in FIG. 11, the high signal (indicated by the first rectangular wave in FIG. 11) as the identification signal. The determination part 23 may determine the quality of the fan motor 10 by identifying the high signal as the identification signal. In the description above, the operation control part 22 applies a predetermined voltage value prior to the normal operation of the fan motor 10. The present disclosure is not limited thereto. The operation control part 22 may apply a predetermined voltage value at predetermined intervals during the normal operation of the fan motor 10.

In the second embodiment described above, the operation control part 22 may apply, to the fan motor 10, an input voltage at which the fan motor main body 11 does not rotate as a predetermined voltage value. The identification signal output part 14 may output, as shown in FIG. 12, the signal indicating a predetermined rotation number (indicated by the rectangular wave in FIG. 12) or higher as the identification signal. The determination part 23 may determine the quality of the fan motor 10, by identifying the signal indicating the predetermined rotation number or higher as the identification signal. In the description above, the operation control part 22 applies a predetermined voltage value prior to the normal operation of the fan motor 10. The present disclosure is not limited thereto. The operation control part 22 may apply a predetermined voltage value at predetermined intervals during the normal operation of the fan motor 10.

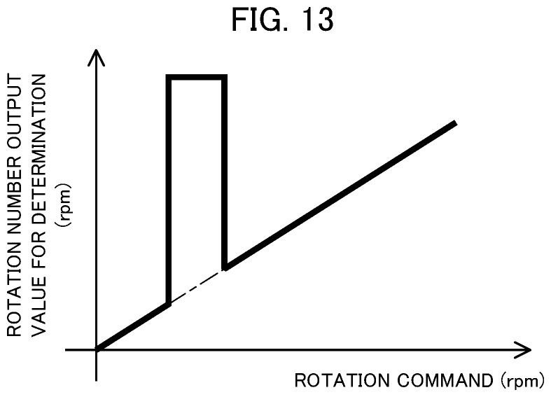

In the third embodiment, the operation control part 22 may control the fan motor 10 at an unusual rotation number for the fan motor main body 11 as a predetermined rotation number. The identification signal output part 14 may output, as shown in FIG. 13, the signal indicating a predetermined rotation number (indicated by the rectangular wave in FIG. 13) or higher as the identification signal. The determination part 23 may determine the quality of the fan motor 10 by identifying the signal indicating the predetermined rotation number or higher as the identification signal. In the description above, the operation control part 22 applies a predetermined voltage value prior to the normal operation of the fan motor 10. The present disclosure is not limited thereto. The operation control part 22 may apply a predetermined voltage value at predetermined intervals during the normal operation of the fan motor 10.

### EXPLANATION OF REFERENCE NUMERALS

1 COOLING DEVICE
10 FAN MOTOR
11 FAN MOTOR MAIN BODY
12 OPERATION SIGNAL OUTPUT PART
13 DETECTION PART
14 IDENTIFICATION SIGNAL OUTPUT PART
20 FAN MOTOR DRIVE DEVICE
22 OPERATION CONTROL PART
23 DETERMINATION PART
101 FAN BLADE

What is claimed is:

1. A fan motor drive device connected to a fan motor, the fan motor drive device configured to drive the fan motor, the fan motor drive device comprising:
an operation control part configured to control operation of the fan motor; and
a determination part configured to determine quality of the fan motor on a basis of an identification signal indicating an operation state of the fan motor, the identification signal output on a basis of a predetermined operation controlled by the operation control part.

2. The fan motor drive device according to claim 1, wherein
the determination part determines the quality of the fan motor by identifying the identification signal indicating an operation state different from an expected operation state by the application of a predetermined voltage value by the operation control part to the fan motor.

3. The fan motor drive device according to claim 2, wherein
the determination part determines the quality of the fan motor by identifying the identification signal indicating a rotation number different from an expected rotation number by the application of a predetermined voltage value by the operation control part to the fan motor.

4. The fan motor drive device according to claim 1, wherein
the determination part determines the quality of the fan motor by identifying the identification signal indicating an operation state different from an expected operation state by predetermined rotational control of the fan motor performed by the operation control part.

5. A fan motor configured to operate by supplied driving power, the fan motor comprising:
a fan motor main body having a plurality of fan blades configured to rotate around an axis;
an operation signal output part configured to convert an operation state of the fan motor main body into a signal and output the signal;
a detection part configured to detect a specific operation state of the fan motor main body; and
an identification signal output part configured to output an identification signal indicating an operation state different from an actual operation state in place of the signal output by the operation signal output part, in response to detection of the specific operation state.

6. A cooling device comprising a fan motor configured to operate by supplied driving power and a fan motor drive device connected to the fan motor,
wherein the fan motor comprises:
a fan motor main body having a plurality of fan blades configured to rotate around an axis;
an operation signal output part configured to convert an operation state of the fan motor main body into a signal and output the signal;
a detection part configured to detect a specific operation state of the fan motor main body; and
an identification signal output part configured to output an identification signal indicating an operation state different from an actual operation state in place of the signal output by the operation signal output part, in response to detection of the specific operation state, and
wherein the fan motor drive device is configured to drive the fan motor, the fan motor drive device comprising: an operation control part configured to control operation of the fan motor; and a determination part configured to determine quality of the fan motor on a basis of an identification signal indicating an operation state of the fan motor, the identification signal output on a basis of a predetermined operation controlled by the operation control part.
